(19) United States
(12) Patent Application Publication
(10) Pub. No.: US 2026/0125808 A1
(43) Pub. Date: May 7, 2026

(54) ELECTRODE ARRAY AND DEVICE FOR HIGH-THROUGHPUT ELECTROSYNTHESIS

(71) Applicant: SYNGENTA CROP PROTECTION AG, Basel (CH)

(72) Inventors: Matthias LEHMANN, Stein (CH); Julian QUEVAREC, Stein (CH); Karlis Eriks KRIKIS, Stein (CH)

(73) Assignee: SYNGENTA CROP PROTECTION AG, Basel (CH)

(21) Appl. No.: 19/119,926

(22) PCT Filed: Oct. 6, 2023
(86) PCT No.: PCT/EP2023/077748

§ 371 Date: Apr. 10, 2025

(30) Foreign Application Priority Data
Oct. 12, 2022 (EP) 22201059.7

(51) Int. Cl. C25B 11/02; B01J 19/00; C25B 3/05; C25B 3/07; C25B 3/09; C25B 9/70; C25B 11/052

(52) U.S. Cl. CPC C25B 11/02; B01J 19/0046; C25B 3/05; C25B 3/07; C25B 3/09; C25B 9/70; C25B 11/052; B01J 2219/00585; B01J 2219/00596; B01J 2219/00713

(57) ABSTRACT

The present invention relates to an electrode array comprising two-electrode assemblies and a corresponding device for use in performing electrochemical synthesis. The invention further relates to use of the device in the high-throughput electrochemical synthesis of chemical compounds, particularly for the purpose of chemical library synthesis and chemical reaction discovery.

### FIELD OF THE INVENTION

The present invention relates to an electrode array and a device for use in performing electrochemical synthesis, such as the synthesis of chemical libraries and chemical reaction discovery. More particularly it relates to automation-ready devices and methods for the high-throughput, parallel electrosynthesis of chemical compounds in milligram quantities and the screening of (electro) chemical reaction parameters.

### BACKGROUND OF THE INVENTION

Chemical libraries are collections of chemical compounds that may be used for the purpose of screening certain classes of compounds for specific interactions with a certain target, such as affinity for binding sites in drug discovery, propensity to catalyse a polymerisation in industrial processes or pesticidal activity in agrochemistry.

Chemical libraries are typically designed jointly by (organic or medicinal) chemists and cheminformatics specialists, and synthesised using a combination of known organic chemistry routes. Alternatively or additionally, synthesis of chemical libraries can be performed by electrochemical synthesis (or “electrosynthesis”), wherein starting materials (substrates) are converted in an electrochemical cell to one or more reaction products under the influence of an applied electric potential or current resulting in one or more redox reactions.

Electrosynthesis may provide benefits over regular organic redox reactions in terms of selectivities and yields obtained. Therefore, in general, electrosynthesis can be a favourable alternative for the preparation of new chemical compounds or classes of chemical compounds.

However, the discovery of new electrochemical reactions-either for the purpose of general synthesis of new compounds or for library generation-requires the design and evaluation of suitable reaction parameters, such as choice of electrode materials, electrolyte, current density etc. Such screening for appropriate parameters and conditions is largely beyond the technical and practical scope of the ordinary organic chemist; it typically requires devising one or several electrochemical reactors using different electrode assemblies and applying numerous iterations of various reaction conditions.

Electrochemistry devices are known in the art, such as for example a microscale 24-well electrochemistry reactor employing an array of two parallel cylindrical rods as electrodes, held closely apart so as to fit in an array of microscale cells of a base plate. The device further contains an alignment plate, sealing plate, custom printed circuit board and an 8-pin connector for connecting to four controllers configured for providing constant current or voltage. This setup allows for the screening of 4 discrete currents or 4 discrete cell voltages depending on the mode of operation. However, the device requires manual handling of all 48 electrodes upon assembly. Furthermore, in order to ensure repeatability of the experiments, the electrodes must be manually cleaned and/or mechanically polished after each reaction to expose an unchanged surface of the electrode material. These labour-intensive processes represent a bottleneck on high-throughput electrosynthesis and hinder the numbering-up of this concept to larger numbers of cells.

US 2020/0384434 A1 describes a device used in the solid-phase synthesis of polymers, wherein the growing polymer chains are individually and covalently bound to a solid support through a linker molecule. The device contains an array of individually addressable electrodes embedded in the solid support, wherein the solid support contains or consists of an integrated circuit (IC). By reversing the bias at specific electrodes in the array, the linker molecules can be selectively cleaved from the support, which allows site-selective release from the polymer chains during synthesis. In a specific embodiment, a positive anode in the array is surrounded by three, four, five, six, seven, eight, nine or more electrodes each configured as a negative cathode. In the device disclosed in US 2020/0384434 A1, the solid support with embedded array of individually addressable electrodes forms the basis of a single electrolytic cell, wherein the release of the polymer product rather than the polymerization reaction itself is brought about by electrolysis. As such, the device is not suited for electrochemical synthesis purposes, which typically requires the controlled application of an electric potential or current from a single electrode (cathode-anode) pair.

Accordingly, there is a hitherto unmet need for electrode arrays and corresponding electrochemical devices for use in electrochemical synthesis, including high-throughput synthesis of chemical libraries and chemical reaction discovery, that are easy to manufacture, modify and maintain. More specifically, there is need to have electrode arrays that can be manufactured in few steps and at low cost, advantageously allowing said electrode arrays to be single-use items, thus avoiding manual handling and laborious post-reaction treatment of the electrodes. There is a further need for electrode arrays and electrochemical devices comprising such arrays, wherein variations in electrode material within the same array can be easily implemented, and that can withstand the currents required for electrochemical synthesis. Additionally, it would be desirable to have access to electrode arrays and devices that allow the reactions to run in parallel with few, simple power drives. Furthermore, it would be helpful to have available electrochemical devices and methods for the rapid synthesis, quantification and isolation of large quantities of chemical compounds, as well as for the screening of appropriate reaction conditions for such electrochemical syntheses.

### SUMMARY OF THE INVENTION

The limitations of the state-of-the-art devices and methods are now overcome by the present invention, which provides parts, devices and methods for high-throughput electrosynthesis of chemical compounds for the purpose of reactions discovery and library synthesis.

Accordingly, in a first aspect the present invention relates to an electrode array comprising two-electrode assemblies for use in performing electrochemical synthesis, said electrode array comprising a plurality of planar monolithic bodies arranged on a planar substrate, wherein said bodies comprise a working electrode region and/or a counter-electrode region, and wherein said bodies are arranged on the substrate to form an m×n matrix (6) of m rows and n columns of two-electrode assemblies formed by the working electrode region of a first body and the counter-electrode region of a second adjacent body in the same column or in the same row, separated by a gap.

The electrode array according to the present invention comprises planar monolithic bodies forming two-electrode assemblies having a thickness and shape particularly suitable for electrochemical synthesis. By not having a third (reference) electrode, the electrode assemblies can be realised in a simple flat design that does not require conducting traces to pass through the substrate, and that can easily be adapted to the specific purpose of the electrochemical reaction. Furthermore, in the electrode array of the invention, the working electrode region and the counter-electrode region of two adjacent bodies in the same column or in the same row may together form a two-electrode assembly. This results in the assemblies in a column or in a row being connected in series, requiring only one power supply per column or row to be connected, which allows an optimal balance between complexity of the electrical circuit and number of parallel reactions (and hence throughput) to be achieved.

The electrode array is combined with plurality of suitable vessel containing the reaction substrate and other components required, such as electrolyte, to form an array of electrochemical cells that can be used for a variety of electrochemical synthesis reactions.

Accordingly, in a second aspect, the present invention relates to a device for performing electrochemical synthesis, comprising the electrode array as defined herein and a plurality of reaction vessels, wherein each of the reaction vessels is configured to provide electrical contact of its content with a single two-electrode assembly of the electrode array.

A benefit of the device of the invention is that a large number of electrochemical conversions can be performed in parallel with different substrates under identical conditions or under controlled varying conditions. This allows using the device of the invention to create chemical libraries in an expedient manner. Moreover, the device of the invention is particularly suitable for so-called reaction discovery, by enabling the rapid screening of electrochemical conversion parameters.

Thus, in a further aspect, the present invention relates to a use of the device according to the invention in chemical library synthesis.

In another aspect, the present invention relates to a use of the device according to the invention in chemical reaction discovery.

In a further aspect, the present invention relates to method for electrochemically converting one or more reactants into reaction products, comprising
providing the electrochemical device according to the invention
providing one or more reactants and optionally solvents and/or electrolytes to the reaction vessels
applying an electrical current between the working electrode and counter electrode of the two-electrode assemblies sufficient for the one or more reactants to be converted into reaction products.

### SHORT DESCRIPTION OF THE FIGURES

FIG. 1 shows a photograph of an electrode array according to an embodiment of the invention.

FIG. 2A shows a schematic representation of a monolithic body with a working electrode region and counter-electrode region.

FIG. 2B shows a schematic representation of two bodies forming a two-electrode assembly.

FIG. 2C shows a schematic representation of a matrix of bodies forming a part of an electrode array according to an embodiment of the invention.

FIGS. 3A, 3B, and 3C show a schematic representation of an electrode array configuration according to another embodiment of the invention, of two bodies forming a two-electrode assembly according to this embodiment, and of a matrix of bodies forming a part of an electrode array according to this embodiment, respectively. FIG. 3D shows a magnified photograph of an array of pyrolytic carbon planar bodies produced by surface laser pyrolysis on polyimide foil.

FIG. 4 shows a photograph of an array of reaction vessels according to an embodiment of the invention.

FIG. 5 shows a photograph of a device according to an embodiment of the invention.

FIG. 6 shows a schematic representation of a power supply and control for the device according to an embodiment of the invention.

### DETAILED DESCRIPTION OF THE INVENTION

The present invention is described in more detail below.

In a first aspect the present invention relates to a an electrode array comprising two-electrode assemblies (6) for use in performing electrochemical synthesis, said electrode array comprising a plurality of planar monolithic bodies arranged on a planar substrate, wherein said bodies comprise a working electrode region and/or a counter-electrode region, and wherein said bodies are arranged on the substrate to form an m×n matrix of m rows and n columns of two-electrode assemblies formed by the working electrode region of a first body (3) and the counter-electrode region of a second adjacent body (3) in the same column or in the same row, separated by a gap.

In the context of the present invention, the term “planar” means having an average thickness dimension that is substantially less than its extent in the other two dimensions, i.e., its length and width dimensions. The monolithic bodies will still be considered planar even if their thickness is not constant if it meets this condition, i.e. they may comprise irregularities, such as for example surface roughness.”

In the context of the present disclosure, “bodies arranged on the substrate” is to be interpreted as meaning that the bodies are arranged onto the surface of the substrate and are not embedded therein to any relevant extent, preferably not at all.

The electrode array as defined herein offers the advantage of having as a base structure an array of planar monolithic bodies comprising a working electrode region and/or a counter-electrode region of which adjacent bodies together are capable of forming a two-electrode assembly of a working electrode and a counter electrode. As such, these two-electrode assemblies lie in the same plane and parallel to the substrate and do not require complex electronic wiring through the substrate. As used herein, the term “monolithic body” should be understood to refer to a shape consisting of one piece, substantially without or without interruptions such as grooves or holes in this shape. The term “monolithic” as used herein does not necessarily mean a single material; the body may be made of a single material or of a composition of different materials, in the latter case preferably as homogeneous as possible.

Typically, the majority the monolithic bodies have both a working electrode region and a counter-electrode region, with only the first and/or last body of the bodies forming a column or a row only requiring either a working electrode region or a counter-electrode region to form a two-electrode assembly with a directly adjacent body.

In an exemplary embodiment, the electrode array comprises a plurality of planar monolithic bodies arranged on a planar substrate, wherein said bodies each comprise a working electrode region and a counter-electrode region. In this embodiment, while not required for proper device operation, the first and last body of the bodies forming a column or a row contain both a working electrode region or a counter-electrode region.

In another exemplary embodiment, the electrode array comprises a plurality of planar monolithic bodies arranged on a planar substrate, the first and last body of the bodies forming a column or a row contain either a working electrode region or a counter-electrode region, while the remaining bodies (i.e., those not taking an edge position) comprise a working electrode region and a counter-electrode region.

Thus, generally, the electrode array according to the present invention comprises a plurality of two-electrode assemblies formed by adjacent and consecutive bodies in either a column or a row. In one embodiment, the electrode array comprises a plurality of two-electrode assemblies formed by adjacent and consecutive bodies in a column. In another embodiment, the electrode array comprises a plurality of two-electrode assemblies formed by adjacent and consecutive bodies in a row.

Hence, within a column of adjacent bodies, in the longitudinal direction of the column, a two-electrode assembly can be formed by the working electrode region of a first body and the counter electrode region of a second, directly adjacent body. As such, the two-electrode assemblies each contain a working electrode and a counter electrode, separated by a gap formed by the spacing between two adjacent bodies. A second two-electrode assembly can in turn be formed by the working electrode region of the second body and the counter-electrode region of third, directly adjacent body in the same column, and so on, resulting in a column of two-electrode assemblies connected in series.

Alternatively, within a row of adjacent bodies, in the longitudinal direction of the row, a first two-electrode assembly can be formed by the working electrode region of a first body and the counter-electrode region of a second, directly adjacent body. A second two-electrode assembly can be formed by the working electrode region of the second body and the counter-electrode region of third, directly adjacent body, and so on, resulting in a row of two-electrode assemblies connected in series.

In one embodiment, at least two two-electrode assemblies in a column or row are connected in series. Preferably, substantially all or all of the two-electrode assemblies in a column or row are connected in series, i.e. each working electrode region and each counter-electrode region of a body forms a two-electrode assembly with a directly adjacent body in the same row. In this way, only one current supply connection per column or row of assemblies connected in series is required, which allows an optimal balance between complexity of the electrical circuit and number of parallel reactions (and hence throughput) of the corresponding electrochemical device to be achieved.

As will be described in detail herein below, the monolithic bodies can be applied using simple, low-cost techniques such as screen-printing, stencil printing, or inkjet printing. Screen-printing of electrode materials on substrates is a well-known technique and provides many benefits including high reproducibility and accuracy, as well as the possibility of easy modification of the electrode geometry and composition off the electrode material. Laser surface pyrolysis is another technique that can be used to fabricate the desired monolithic bodies, especially pyrolytic carbon bodies. One cites the following reference for characterizing carbon bodies: Merlen, A.; Buijnsters, J. G.; Pardanaud, C. A Guide to and Review of the Use of Multiwavelength Raman Spectroscopy for Characterizing Defective Aromatic Carbon Solids: from Graphene to Amorphous Carbons; Coatings 2017, 7, 153.

Depending on the choice of material for the body and the application technique, the electrode array can be produced at such low costs that it can be used once only. Hence, in an embodiment, the electrode-array is a single-use electrode array.

The bodies are arranged such that they form a matrix of two-electrode assemblies. Preferably, the matrix is a rectangular matrix. The matrix has m rows and n columns, wherein m and n are each non-zero integers. Hence, each row mᵢ with i=1, 2 . . . n has n two-electrode assemblies and each column nⱼ with j=1, 2 . . . m has m two-electrode assemblies.

As such, the m×n matrix of m rows and n columns of two-electrode assemblies is formed by the working electrode regions and the counter-electrode regions of adjacent consecutive bodies in the same column nⱼ or in the same row mᵢ.

In general, the bodies forming the matrix of two-electrode assemblies are arranged such that the distances between the assemblies are substantially equal or equal. Herein, the “distance between the assemblies” can be the centre-to-centre distance or the edge-to-edge distance, depending on the geometry of the bodies and resulting electrode assemblies; i.e., for substantially symmetric geometries either distance will be an appropriate measure, whereas for asymmetric designs the centre-to-centre distance would be a more usable parameter.

In a preferred embodiment, the two-electrode assemblies are arranged at substantially equal mutual equal distances (8), wherein the distance between the two-electrode assemblies is selected such that this enables the matrix of two-electrode assemblies to form the respective bottoms of the wells of a multi-well plate having m rows and n columns. Advantageously, this allows the electrode array to be combined with standard size laboratory equipment such as, commercially available, multi-well plates.

In an exemplary embodiment of the invention, the matrix dimensions of the electrode array and the spacing between the two-electrode assemblies correspond to the dimensions and well-to-well spacing of a standard Society for Biomolecular Screening (SBS) multi-well plate, such as a well plate having 12 (3×4), 24 (4×6), 48 (6×8), 96 (8×12), 384 (16×24) or 1536 (32×48) wells. Thus, in an embodiment, m, n and the distance (8) correspond to those of a standard Society for Biomolecular Screening (SBS) 12 (3×4), 24 (4×6), 48 (6×8), 96 (8×12), 384 (16×24) or 1536 (32×48)-well plate. In a preferred embodiment, said parameters correspond to those of a standard SBS 96-well or 384-well plate.

The monolithic bodies providing the working electrode region and a counter-electrode regions can be made of any suitable electrically conductive material. In an exemplary embodiment, the bodies comprise, substantially consist of or consist of a carbon-based material. Non-limiting examples of suitable carbon-based electrode materials are graphite, expanded graphite, graphene, carbon, glassy carbon, nanocarbon, and pyrolytic carbon. Depending on the deposition technique used for application of the electrode array, for example screen-printing, the bodies may contain (small) amounts of other materials such as binder.

The monolithic bodies forming together the two-electrode assemblies as disclosed herein should have a thickness that is sufficient to withstand the currents and/or current densities required for the electrochemical conversion reactions envisaged with the device. Typically, the thickness of the planar single-material bodies is in the range of 1-500 μm, preferably 10-500 μm, preferably 20-400 μm, preferably 30-300 μm, and more preferably 50-300 μm.

It is possible to apply a coating of another conductive material on at least a portion of the working electrode region of one or more, or all, of the electrode assemblies. The conductive coating applied on the working electrode region will function as the working electrode in the corresponding electrochemical cell. As a result, the use of conductive working electrode coatings expands the scope of available electrode materials and electrode combinations (and hence electrode potentials), and allows for expedient screening of suitable electrodes and electrode combinations in reaction discovery. Thus, in an embodiment a plurality of the two-electrode assemblies comprise a working electrode region which is at least partially provided with an electrically conductive coating layer, wherein said coating layer acts as the working electrode of the corresponding two-electrode assembly. Examples of suitable materials that can be used, alone or in combination, such coating layers include, but are not limited to, graphite, glassy carbon, boron-doped diamond, Co, Fe, W, Sn, Pb, Ag, Ta, Cr, Mn, Mo, Ti, Zr, Hf, V, Nb, Au, Pt, Zn, Ni, Al, Cu, and Mg. It will be appreciated that instead of one, also multiple layers of coatings can be applied.

It is not mandatory that all working electrodes or working electrode regions are provided with the same coating. Rather, an advantageous aspect of this embodiment of the invention is that multiple, different types of coatings, e.g. different coating compositions, can be used within a single electrode array. For example, it is possible to provide a first column or row of electrode assemblies with a first coating and a second column or row of electrode assemblies with a second coating, wherein the first coating and the second coating are different, and optionally so on for a third, fourth etc. column or row. Advantageously, this allows for easy screening of suitable electrode materials for the purpose of reaction discovery. Accordingly, in one embodiment, dissimilar coating layers are present on at least two. In another embodiment, dissimilar coating layers are present on each column or each row of the electrode array. In yet another embodiment, substantially all, or all, of the two-electrode assemblies are provided with a different coating on the working electrodes or working electrode regions thereof.

As explained previously, within a column or row of adjacent bodies, depending on the layout of the electrode array, the two-electrode assemblies each contain a working electrode and a counter electrode, separated by a gap formed by the spacing between two adjacent monolithic bodies. As such, depending on the dimension and shape of these adjacent bodies, as well as their spacing, the width of this gap may vary. This gap width may influence the functioning of the corresponding individual electrochemical cell in the full device; for example a smaller gap width gap reduces the voltage drop over the cell, but increases the risk of a short-circuit condition. Typically, the width of the gap is in the range 0.01-10 mm, preferably 0.1-4 mm, most preferably 0.5-2 mm.

In a second aspect the invention relates to a device for performing electrochemical synthesis, comprising the electrode array as defined herein and a plurality of reaction vessels, wherein each of the reaction vessels is configured to provide electrical contact of its content with a single two-electrode assembly of the electrode array.

The device according to the invention combines the electrode array as disclosed herein with a plurality of suitable reaction vessels, wherein each reaction vessel allows its content to be in electrical contact with one electrode assembly so as to form a device comprising plurality of electrochemical cells. As such, the electrode assemblies of the electrode array of the invention each individually form the bottom of a single electrochemical cell.

In one embodiment, the plurality of reaction vessels is formed by a plurality of droplets, wherein each droplet is in electrical contact with one electrode assembly, and wherein each droplet contains the components required for an electrochemical conversion reaction, such as one or more starting materials (substrates) and a solvent and/or electrolyte.

In another embodiment, the plurality of reaction vessels is formed by a plate comprising a plurality of holes, wherein typically each hole individually forms the walls of a single reaction vessel, and wherein the dimension and spacing of the holes correspond to those of the electrode assemblies forming the respective bottoms of the resulting electrochemical cells. Such a plate comprising a plurality of, preferably equidistant, holes can be made of any material capable of holding and withstanding the effects of reactive chemicals. In an embodiment, the plate is a monolithic plate, preferably a monolithic polymer plate. In an exemplary embodiment, the monolithic plate is a 3D-printed polymer plate.

Typically, each reaction vessel extends in a direction that is substantially perpendicular, or perpendicular, to the planar substrate.

Typically, the volume of each reaction vessel of the plurality of reaction vessels is in the range of 1-3000 μL, preferably 10-1000 μL, most preferably 50-300 μL.

Advantageously, the combination of the electrode array and the reaction vessels provides an array of miniature electrochemical cells. Preferably, the dimensions as well as the mutual spacing of these cells correspond to those of the wells of standard Society for Biomolecular Screening (SBS) multi-well plate, thus allowing for easy compatibility with existing laboratory equipment.

In a preferred embodiment, the dimensions and mutual arrangement of the two-electrode assemblies and reaction vessels correspond to those of the wells of a standard Society for Biomolecular Screening (SBS) multi-well plate. Preferably, they correspond to those of a standard Society for Biomolecular Screening (SBS) 12 (3×4), 24 (4×6), 48 (6×8), 96 (8×12), 384 (16×24) or 1536 (32×48)-well plate, preferably a 96- or a 384-well plate.

In order to perform electrochemical conversions, the device must be connected to a suitable current source. Thus, in an embodiment the device further comprises one or more current supply units. In principle, any type of power source can be used, provided it is capable of providing a constant current through each of the electrochemical cells formed by the array of two-electrode assemblies and the corresponding reaction vessels. Suitable current sources are available commercially, examples of which are multichannel DC power supplies available from Rohde & Schwarz HMP4000 Power supply series, and the skilled person will be able to implement one or more of these current sources appropriate for a given purpose. Electrical contacts can be provided using means known to the skilled person, such crocodile clips, soldering etc. Typically, the current supply unit is configured to provide a substantially constant or constant current output in the range of 0.01 mA-1000 mA, preferably 0.1-20 mA, most preferably 0.5-10 mA.

In the device of the present invention, typically the two-electrode assemblies are formed by the working electrode region of a first body and the counter-electrode region of a second adjacent body in the same column nⱼ or in the same row mᵢ, as such, the two-electrode assemblies in a column or row, respectively, are electrically connected in series through the successive monolithic bodies. Hence, the number of current supplies is typically equal to or lower than the number of rows or columns in the electrode array, depending on whether a column or a row in the matrix array forms the series circuit. Preferably, the number of current supplies equals the number of rows or columns forms the series connection in the electrode array, in order that each of the m×n two-electrode assemblies is electrically connected.

Advantageously, the planar configuration of the electrode array and the in-series connection in the columns or rows of electrode assembly matrix requires electrical contacts for the current supply to be only connected at the edges of the substrate, which greatly simplifies manufacturing, operation and maintenance of the device.

The current strength and the duration of the supply of current can be regulated using equipment and procedures known to the skilled person, and are either commercially available or can be developed in-house.

The device as disclosed herein can be used for a variety of electrochemical applications. The device of the invention is particularly suitable for high-throughput electrochemical conversion of suitable starting materials into target chemical compounds. Accordingly, in one aspect, the invention relates to the use of the device according to as disclosed herein in the electrochemical synthesis of chemical compounds. In one embodiment, the use involves chemical library synthesis. In another embodiment, the use involves chemical reaction discovery.

The method of the invention is applicable to a broad range of electrochemical reactions. Non-limiting examples of reduction or oxidation reactions of organic compounds that are suitable for use with the method and device of the invention are electrochemical cross-coupling reactions and functional group interconversions including (oxidative) C—N/N—H cross-coupling reactions, metabolite synthesis, alcohol to ketone to acid conversion, nitrile reductions, cross-electrophile coupling, Shono oxidation, and biaryl coupling reactions.

In a further aspect, the present invention provides method for electrochemically converting one or more reactants into reaction products, comprising
providing the electrochemical device as defined herein
providing one or more reactants and optionally solvents and/or electrolytes to the reaction vessels
applying an electrical current between the working electrode and counter electrode of the two-electrode assemblies sufficient for the one or more reactants to be converted into reaction products

Suitable solvents and electrolytes for electrochemical synthesis are known to the skilled person. Non-limiting examples are tetrabutylammonium hydroxide (Bu₄NOH), sodium pivalate, tetrabutylammonium tetrafluoroborate (Bu₄NBF₄), ethyltriethylammonium tetrafluoroborate, tetraethylammonium tetrafluoroborate, tetraethylammonium chloride (TEAC), 1-butyl-3-methyl-imidazolium tetrafluoroborate, sodium acetate, lithium perchlorate, sodium sulphate, aqueous solutions of potassium hydroxide (KOH), sodium hydroxide (NaOH), hydrogen chloride (HCl) or sulphuric acid (H₂SO₄), and ionic liquids.

The reaction products are worked-up, analysed and purified using methods and equipment known in the art. In an embodiment, the dimensions and mutual arrangement of the two-electrode assemblies and reaction vessels correspond to a standardised multi-well plate as derived above, and work-up of the reaction products can suitably be carried out using automated liquid handling and sample collection. Analysis of intermediates and reaction products can be done by known techniques such as LC-MS, GC, and NMR, Isolation of reactions can be carried out, for example, by preparative HPLC.

The method can be performed, depending on the geometry of the bodies forming the two-electrode assemblies (i.e., connected in series in a row or in column), row by row or column by column by electrically connecting the rows or columns to a current source. In a preferred embodiment, all rows or all columns of the electrode array matrix are connected, so that all reactions are carried out in parallel. Preferably, these reactions differ in one or more aspects, such that different reaction products are obtained, and/or different yields are obtained, and/or optimum process conditions can be discovered.

Hence, in a preferred embodiment, a plurality of different electrochemical conversions are carried out in parallel, wherein the electrochemical conversions differ in one or more of the following aspects:
reactants provided to the reaction vessel
reactant concentrations present in the reaction vessel
solvents provided to reaction vessel
electrolytes provided to reaction vessel
counter-electrode materials
working electrode materials
working electrode coating materials
current density
charge passed

In an embodiment, at least two of the electrochemical conversions are performed using different working electrode materials. This can suitably be attained by applying coatings of different materials on the working electrode region of the bodies forming the corresponding two-electrode assemblies; as such, said coatings of suitable conductive materials then function as the working electrode for each two-electrode assembly concerned.

The electrode array according to the present invention can be generally prepared by creating a pattern forming the two-electrode assemblies on a suitable substrate material, optionally followed by the application of one or more coating layers on selected portions of the array, particularly the working electrode region of one or more of the two-electrode assemblies.

Accordingly, in an aspect, the invention pertains to a method for manufacturing of the electrode array according to the present invention, comprising the steps of
providing a substrate;
creating a pattern forming the two-electrode assemblies on the surface of the substrate;
optionally, applying a coating layer onto at least a portion of the working electrode region of one or more of the two-electrode assemblies.

The substrate may be any electrically non-conductive, flat substrate, such as glass, ceramic or polymer.

The pattern forming the two-electrode assemblies may, for example, be created by applying a suitable composition comprising the electrode material onto the substrate. The composition comprising the electrode material may be suspension, an ink or a paste comprising the electrode material in powder form. Application of the composition comprising the electrode material can be done in various ways known in the art, such as screen-printing, stencil printing, or inkjet printing. In an exemplary embodiment, screen-printing is used, which is a low-cost technique that provides many benefits including high reproducibility and accuracy, as well as the possibility of easy modification of the electrode geometry and composition off the electrode material.

Hence, in an exemplary embodiment, there is provided a method for manufacturing of the electrode array according to the present invention, comprising the steps of
providing a substrate;
providing a composition comprising the electrode material;
applying the composition comprising the electrode material onto the substrate to obtain a pattern forming the two-electrode assemblies;
optionally, applying a coating layer onto at least a portion of the working electrode region of one or more of the two-electrode assemblies.

Another suitable method for creating a pattern forming the two-electrode assemblies on a substrate material is by photothermal surface pyrolysis of a suitable carbon-based substrate material, such as polyimide foil. For example, by moving a laser beam with defined fluence and wavelength at controlled speed over the surface of the polyimide foil, local heating and carbonization (graphitization) of the polyimide surface occurs. This allows the formation of pyrolytic carbon traces of, for example, ca. 300 micron width and height of ca. 40 micron. The laser head can be mounted on a XY table, thus enabling the patterning of any area of the substrate with carbon traces. By overlapping the pyrolytic carbon traces, the desired planar array of conductive bodies can be obtained. Advantageously, this process can be scaled up economically to a roll-to-roll process using, for example, laser/galvo scanning equipment. Other advantages of the surface pyrolysis method for preparing electrode patterns according to the present invention is that it requires no consumables other than the organic substrate material, and results in electrode arrays of superior chemical resistance due to the inherent chemical compatibility of the substrate material and the carbon traces.

Thus, in another exemplary embodiment, there is provided a method for manufacturing of the electrode array according to the present invention, comprising the steps of
providing a substrate;
subjecting the substrate to photothermal carbonization to create a graphitic carbon pattern forming the two-electrode assemblies;
optionally, applying a coating layer onto at least a portion of the working electrode region of one or more of the two-electrode assemblies.

In this embodiment, the substrate material can be any carbon-based material that is susceptible to photothermal, such as laser-induced, conversion to graphitic carbon, examples of which include polyimide, poly-dimethylsiloxane and cellulose.

As described above, in all embodiments, optionally, a coating layer of another conductive material is applied on at least a portion of the working electrode region of one or more, or all, of the electrode assemblies. The conductive coating applied on the working electrode region will function as the working electrode in the corresponding electrochemical cell. As such, the application of different coating layers as the working electrode in the electrode array and the corresponding electrochemical device allows for screening of suitable electrode materials and material combinations.

Depending on the particular choice of material, or combination of materials, such coating layers are suitably applied with thin layer deposition techniques known in the art, such as chemical vapour deposition, spray-coating, electrodeposition, or printing techniques including screen-printing, stencil printing, or inkjet printing.

In order to assemble the complete electrochemical device, suitable reaction vessels and one or more current supplies in electrical contact with the electrode assemblies should be added. As explained herein above, a plurality of droplets, wherein each droplet is in electrical contact with one electrode assembly, and wherein each droplet contains the components required for an electrochemical conversion reaction, such as one or more starting materials (substrates) and a solvent and/or electrolyte, could suitable form the reaction vessels. In another embodiment, a plate comprising a plurality of holes, wherein typically each hole individually forms the walls of a single reaction vessel, is connected to the electrode array. In both designs, each two-electrode assembly of the electrode array is configured to form the bottom of an individual electrochemical cell, the individual electrochemical cells together with one or more current supply units forming the complete electrochemical device.

The electrode array and the plate comprising a plurality of holes can be connected by any suitable means. In an embodiment, the electrode array and the plate comprising a plurality of holes are connected through bonding with a resin, such as an epoxy resin, preferably a low-viscosity epoxy resin, such as for example the epoxy resin commercialized by Huntsman Corp. under the reference Araldite RAPID, or commercialized by Masterbond under the reference EP41S-5. In another embodiment, the electrode array and the plate comprising a plurality of holes are sealed together using a suitable frame. Combinations of such chemical and mechanical connection options are also possible.

### DETAILED DESCRIPTION OF THE DRAWINGS

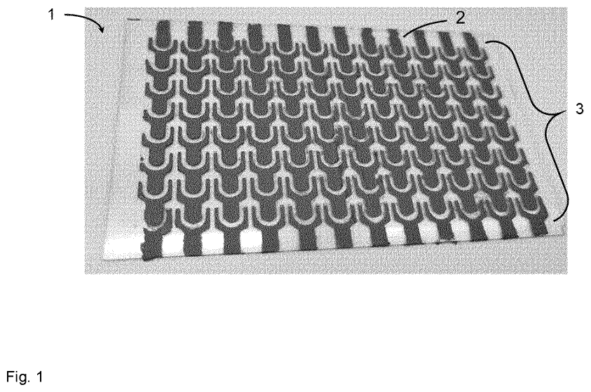

FIG. 1 shows a photograph of an electrode array 1 according to an embodiment of the invention. The 8×12 electrode array contains 8 rows and 12 columns of planar monolithic bodies screen-printed on a glass substrate 2, wherein the working electrode regions 4 and counter-electrode regions 5 of adjacent bodies 3 in a column together form a column of two-electrode assemblies 6 in series.

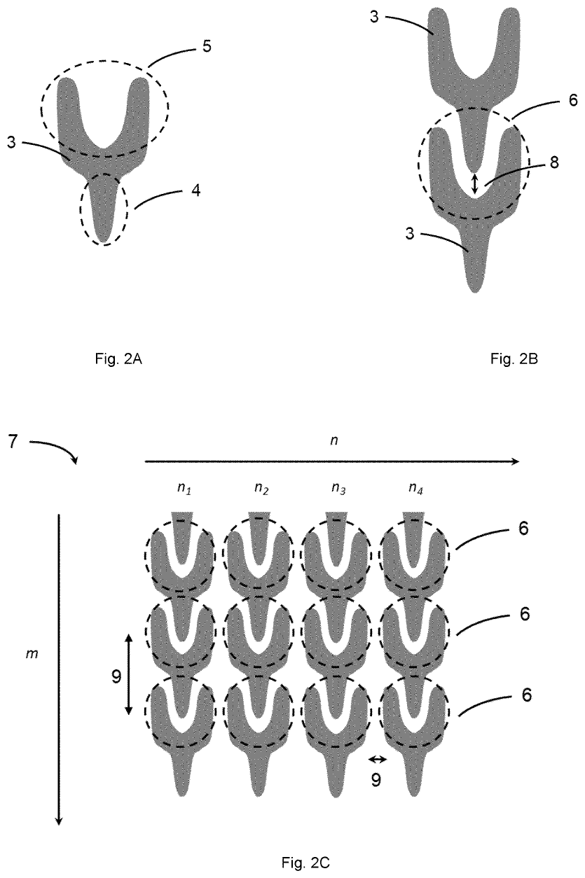

FIG. 2 shows a schematic representation of a part of the electrode array as shown in FIG. 1. FIG. 2A represents a monolithic body 3 with a working electrode region 4 and a counter-electrode region 5. FIG. 2B displays two adjacent monolithic bodies 3 separated by a gap 8 forming a two-electrode assembly 6. FIG. 2C shows a schematic representation of a matrix 7 of bodies 3 forming a part of an electrode array according to an embodiment of the invention. The matrix 7 has m rows and n columns of monolithic bodies 3. For each column nᵢ with i=1, 2, 3, . . . m, the working electrode regions 4 and counter-electrode regions 5 of adjacent bodies 3 form two-electrode assemblies 6 separated by a distance 9.

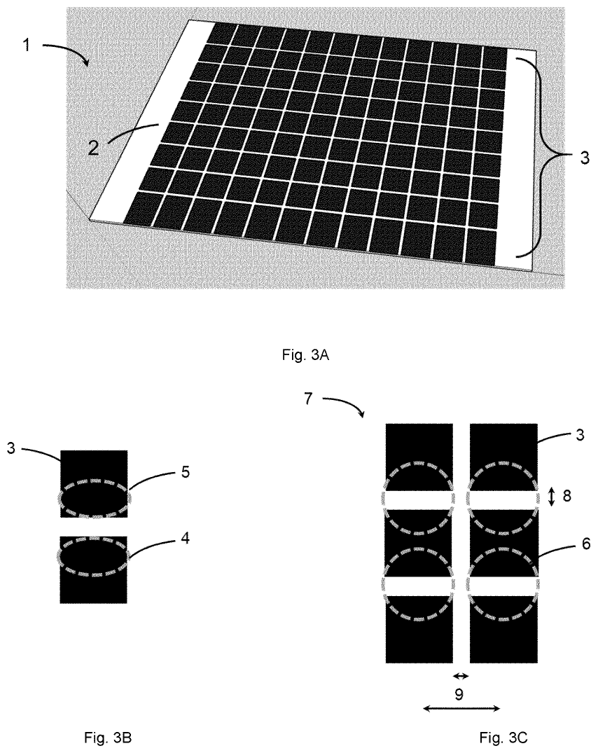

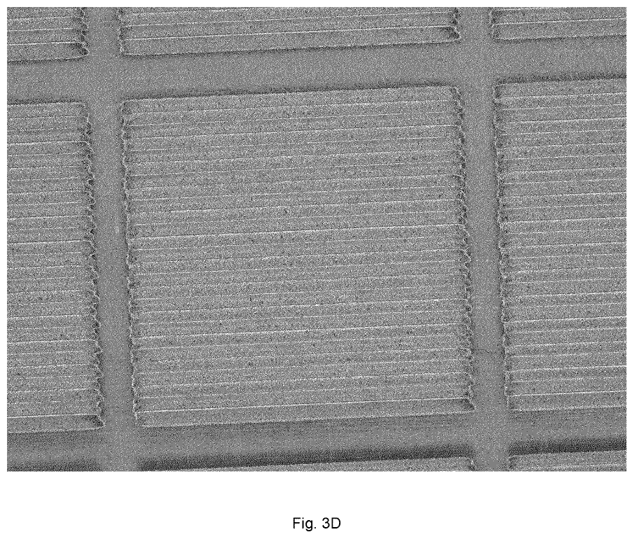

FIG. 3A is a schematic representation of an electrode array configuration according to another embodiment of the invention, containing substantially rectangular monolithic bodies 3. FIG. 3B schematically represents two monolithic bodies 3 having a working electrode region 4 and a counter-electrode region 5 separated by a gap 8. FIG. 3C schematically represents adjacent bodies 3 in a column forming a matrix 7 of two-electrode assemblies 6 separated by a mutual (edge-to-edge or centre-to centre) distance 9. FIG. 3D shows a magnified photograph of an array of carbon planar bodies according to this embodiment produced by surface laser pyrolysis on polyimide foil. The bodies are formed from adjoining strips of graphitic carbon of about 300 microns in width and have a height of about 40 microns.

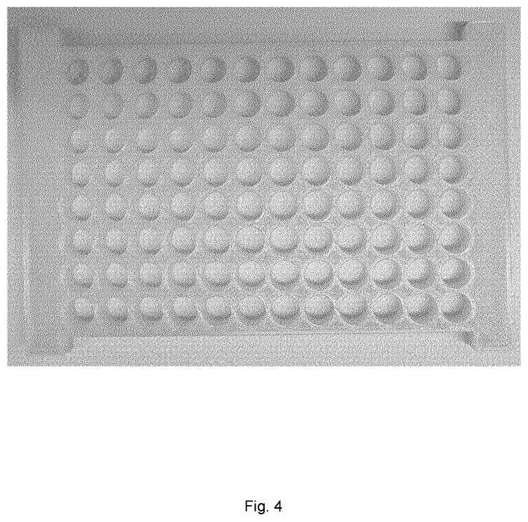

FIG. 4 shows a photograph of an 8×12 array of reaction vessels according to an embodiment of the invention. The array of reaction vessels is formed by a Nylon plate comprising equidistant holes, prepared by 3D printing.

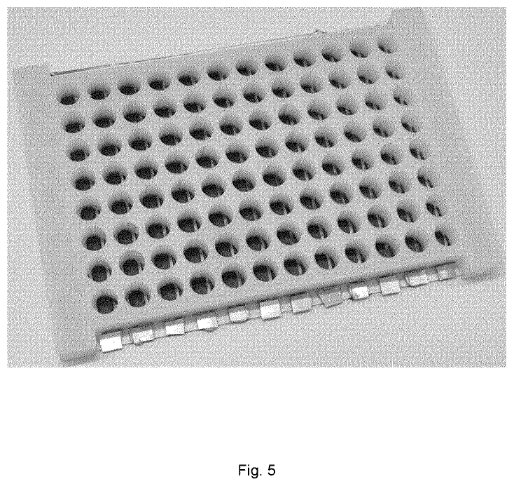

FIG. 5 shows a photograph of a device, excluding current supplies, according to an embodiment of the invention. The device includes an 8×12 electrode array as shown in FIG. 1 in combination with an 8×12 array of reaction vessels as shown in FIG. 4 bonded using a low-viscosity epoxy-resin.

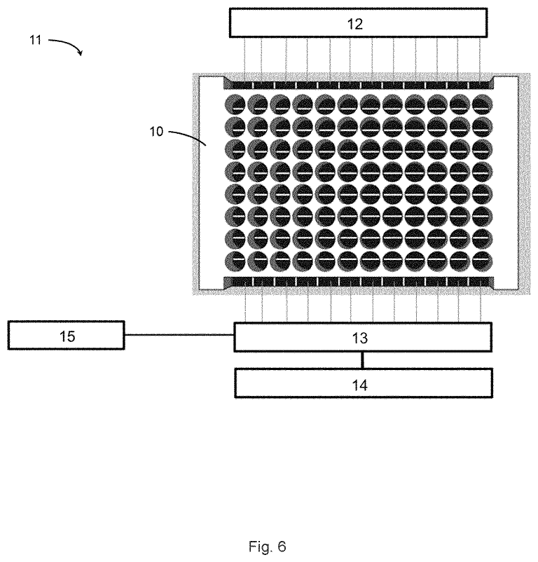

FIG. 6 shows a schematic representation of an assembly 11 of a power supply and a control for the device according to an embodiment of the invention. In the device 10 schematically displayed, each of the twelve columns comprising a series of two-electrode assemblies connected in series is connected to a common supply voltage 12 and a 12-channel current limiter 13 connected to ground 14. 12-channel current limiter 13 is controlled using software running on a computer 15.

### EXAMPLES

The present invention will be further explained, illustrated, and described in the following examples of systems of the present invention. The examples demonstrate the utility and/or function of the invention and help provide a full description of the invention. The examples are intended to be illustrative and not limitative of the present invention.

### Example 1.1: Device Preparation Including a Printing Method

### Step 1: Preparation of Printing Paste

A graphite-containing printing paste was prepared as follows:

PDVF (615 mg, powder, Aldrich) was added to NMP (3.49 g) and the mixture was heated to 50° C. and treated with ultrasound for 12-48 h until a clear, viscous solution was obtained. Graphite (2.68 g, 20 micron particle size, synthetic, Aldrich) was added and dispersed thoroughly by mechanical stirring.

### Step 2: Fabrication of Electrode Array

An electrode array was fabricated by stencil printing (stencil: 0.10 mm stainless steel sheet, cut by WaterJet to provide cut-outs for bodies yielding 8×12 two-electrode assemblies) of the graphite-containing printing paste of Step 1 on a glass plate (float glass, 1 mm thick, manually cut). The array was dried at 80° C. for 16 h in air to provide an array of planar monolithic bodies for 8×12 two-electrode assemblies, having a thickness of about 0.1 mm. A photograph of the electrode array is provided as FIG. 1.

### Step 3: Fabrication of Well Plate Device

A polymer plate comprising an array of 8×12 holes (Nylon, 3D-printed in-house) was bonded using a low-viscosity epoxy resin (Araldite RAPID commercialized by Huntsman Corp.) on top of the electrode array obtained in Step 2 to obtain 8×12 wells configured for receiving and holding a reaction mixture.

In an alternative embodiment for Step 3, the polymer plate comprising an array of 8×12 holes is pressed on top of the electrode array obtained in Step 2 by means of a suitable frame and gaskets to obtain 8×12 wells configured for receiving and holding a reaction mixture.

### Step 4: Connection of Current Supply and Control

Twelve independently controlled current supplies with a current rating of >10 mA and a voltage rating of >64 V were connected using three commercially available four-channel power supplies, from Rohde & Schwarz HMP4000 Power supply series. The power supplies were connected to the well plate device of Step 3 using crocodile clips connecting each of the 12 columns of the 8×12 electrode array independently. The current could be set individually for each column, as well as the electrolysis time.

### Example 1.2: Device Preparation Including a Laser Pyrolysis Method

### Step 1: Fabrication of Pyrolytic Carbon Electrode Array

An electrode array was fabricated by laser pyrolysis of a polyimide foil. A piece of polyimide foil (0.25 mm thickness, Flexiso FI 16000, Dietrich Müller GmbH) was placed on an aluminium plate (5 mm thickness, equipped with double-sided tape to keep the foil in place) in the working area of a laser cutter (Xtool D1 Pro, 40 W, controlled by Lightburn software). The focus of the laser head was adjusted to −10 mm. In the Lightburn software, a CAD representation of the electrode array was drawn. The laser conditions were set up (engraving mode, 3200 mm/min speed, 11.7% power, 0.30 mm line interval), and the laser was started. After the pyrolysis was finished to obtain a pyrolytic carbon electrode array, the laser focus was adjusted to 0 mm, the laser conditions were modified for cutting (cutting mode, 3000 mm/min speed, 60% power, 1 pass), the appropriate CAD drawing was selected, and the program was started again.

### Step 2: Fabrication of Hole Array Plate

A plate comprising an array of 8×12 holes was produced by laser cutting. A polyamide plate (PA 6, 5 mm thickness, Maagtechnic) was placed in the working area of a laser cutter (Xtool D1 Pro, 40 W, controlled by Lightburn). The focus of the laser head was adjusted to 0 mm. In the Lightburn software a CAD representation of the hole array plate was drawn. The laser conditions were set (cutting mode, 400 mm/min speed, 100% power, 2 passes), and the laser was started. After the run, the hole array plate was deburred and sanded.

### Step 3: Fabrication of Well Plate Device

The electrode array obtained in Step 1 and the hole array plate obtained in step 2 were bonded using a chemically resistant epoxy resin (Araldite RAPID commercialized by Huntsman Corp.) to obtain 8×12 wells that are configured for receiving and holding a reaction mixture. Other epoxy resins can be used such as the resin commercialized by Masterbond under the reference EP41S-5.

### Step 4: Connection of Current Supply and Control

Twelve independently controlled current supplies with a current rating of >10 mA and a voltage rating of >64 V were connected using three commercially available four-channel power supplies, from Rohde & Schwarz HMP4000 Power supply series. The power supplies were connected to the well plate device of Step 3 connecting each of the 12 columns of the 8×12 electrode array independently. The current could be set individually for each column, as well as the electrolysis time.

### Step 5: Electrodeposition of Platinum (Pt)

An aqueous stock solution containing chloroplatinic acid (0.043 mol/L) and H₂SO₄ (0.020 mol/L) was prepared. To each well of the well plate device prepared above, 100 μL of the stock solution was added. The device was placed on an orbital shaker and the shaking frequency was adjusted to 400 rpm. A constant current 6.6 ma (30 mA/cm²) was applied for 1.6 min, resulting in Pt deposition on the cathode. The wells were washed with H₂O followed by MeOH and allowed to dry in air at room temperature.

### Example 2: Reaction Discovery

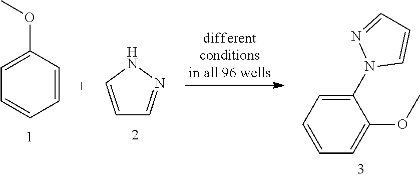

In this experiment optimum electrosynthetic conditions, in particular electrode material and solvent/electrolyte for obtaining compound 3 in high yields are investigated.

The experiment is conducted in an electrochemical 96-well plate device according to the present invention with an all-graphite electrode array, where the working electrodes of each row are coated with a thin layer (<50 μm) of the following materials:
row 1: [uncoated],
row 2: glassy carbon,
row 3: IrO₂,
row 4: RuO₂,
row 5: Pt,
row 6: TiO,
row 7: boron-doped diamond,
row 8: TiN

Veratrole (1, 0.01 mmol) and 5-Methoxy-1,2,3-triazole (2, 5.0 eq) are added into each well. Into each well in each column of the plate, the following solvents (0.10 ml 10 ml/mmol) and electrolytes (0.5 eq), respectively, are added:
Column 1: methanol (MeOH), tetrabutylammonium hydroxide (Bu₄NOH);
Column 2: methanol (MeOH), sodium pivalate (NaOPiv);
Column 3: methanol (MeOH), tetrabutylammonium tetrafluoroborate (Bu₄NBF₄);
Column 4: acetonitrile (MeCN), tetrabutylammonium hydroxide (Bu₄NOH);
Column 5: acetonitrile (MeCN), sodium pivalate (NaOPiv);
Column 6: acetonitrile (MeCN), tetrabutylammonium tetrafluoroborate (Bu₄NBF₄);
Column 7: dimethyl sulfoxide (DMSO), tetrabutylammonium hydroxide (Bu₄NOH);
Column 8: dimethyl sulfoxide (DMSO), sodium pivalate (NaOPiv);
Column 9: dimethyl sulfoxide (DMSO), tetrabutylammonium tetrafluoroborate (Bu₄NBF₄)
Column 10: hexafluoroisopropanol (HFIP), tetrabutylammonium hydroxide (Bu₄NOH);
Column 11: hexafluoroisopropanol (HFIP), sodium pivalate (NaOPiv);
Column 12: hexafluoroisopropanol (HFIP), tetrabutylammonium tetrafluoroborate (Bu₄NBF₄)

A current supply is connected to the electrical contacts on both sides of each column, and a current of 1.0 mA is passed for 60 min.

Characterization and quantification of reaction products 3 is performed using methods and equipment known in the art, including NMR, GC-MS, and HPLC.

### Example 3: Library Preparation

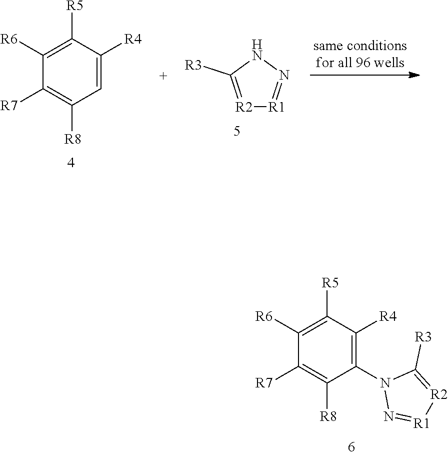

This experiment is conducted in an electrochemical 96-well plate with an all-graphite electrode array. Into each column of the 96 well plate, one of 12 different aryl educts 4 (0.10 mmol) is introduced. Into each row of the electrochemical 96 well plate, one of 8 different azole educts 5 (0.30 mmol, 3.0 eq) is added. NaOPiv (0.5 eq) is added to all 96 wells, followed by MeOH (0.10 ml, 1.0 ml/mmol). A current supply is connected to the electrical contacts on both sides of each column, and a current of 10 mA is passed for 60 min.

Characterization and quantification of reaction products 6 is performed using methods and equipment known in the art, including NMR, GC-MS, and HPLC.

1. An electrode array comprising two-electrode assemblies for performing electrochemical synthesis, said electrode array comprising a plurality of planar monolithic bodies arranged on a planar substrate, wherein said bodies comprise a working electrode region and/or a counter-electrode region, and wherein said bodies are arranged on the substrate to form an m×n matrix of m rows and n columns of two-electrode assemblies formed by the working electrode region of a first body and the counter-electrode region of a second adjacent body in the same column nⱼ or in the same row mᵢ, separated by a gap.

2. The electrode array according to claim 1, wherein the two-electrode assemblies are arranged at substantially equal mutual equal distances, wherein the distance between the two-electrode assemblies is selected such that this enables the matrix of two-electrode assemblies to form the respective bottoms of the wells of a multi-well plate having m rows and n columns.

3. The electrode array according to claim 2, wherein m, n and the distance correspond to those of a standard Society for Biomolecular Screening (SBS) 12 (3×4), 24 (4×6), 48 (6×8), 96 (8×12), 384 (16×24) or 1536 (32×48)-well plate, preferably a 96-well or 384-well plate.

4. Electrode array according to claim 1, wherein the thickness of the planar monolithic bodies is in the range of 10-500 μm, preferably 20-400 μm, more preferably 30-300 μm, and most preferably 50-300 μm.

5. Electrode array according to claim 1, wherein a plurality of the two-electrode assemblies comprise a working electrode region which is at least partially provided with an electrically conductive coating layer.

6. Electrode array according to claim 5, wherein dissimilar coating layers are present on at least two, preferably all, of the two-electrode assemblies.

7. A device for performing electrochemical synthesis, comprising the electrode array according to claim 1, and a plurality of reaction vessels, wherein each of the reaction vessels is configured to provide electrical contact of its content with a single two-electrode assembly of the electrode array.

8. Device according to claim 7, wherein the plurality of reaction vessels is formed by plate comprising a plurality of holes, preferably equidistant holes.

9. Device according to claim 7, wherein the dimensions and mutual arrangement of the two-electrode assemblies and reaction vessels correspond to those of the wells of a standard Society for Biomolecular Screening (SBS) multi-well plate, preferably a 96- or a 384-well plate.

10. Use of the device according to claim 7 in the electrochemical synthesis of chemical compounds, preferably wherein the use involves chemical library synthesis or chemical reaction discovery.

11. A method for electrochemically converting one or more reactants into reaction products, comprising
providing the electrochemical device according to claim 7;
providing one or more reactants and optionally solvents and/or electrolytes to the reaction vessels;
applying an electrical current between the working electrode and counter electrode of the two-electrode assemblies sufficient for the one or more reactants to be converted into reaction products.

12. Method according to claim 11, wherein a plurality of different electrochemical conversions are carried out in parallel, wherein the electrochemical conversions differ in one or more of the following aspects:
reactants provided to the reaction vessel
reactant concentrations present in the reaction vessel
solvents provided to reaction vessel
working electrode materials
current density
charge passed.

13. Method according to claim 12, wherein at least two of the electrochemical conversions are performed using different working electrode materials

14. Method according to claim 11, wherein the electrochemical conversions comprise one or more of electrochemical cross-coupling reactions and functional group interconversions, such as C—N/N—H cross-coupling reactions, metabolite synthesis, alcohol to ketone to acid conversion, nitrile reductions, cross-electrophile coupling, Shono oxidation, and biaryl coupling reactions.

15. Method for the manufacturing of the electrode array according to claim 1, comprising the steps of
providing a substrate;
creating a pattern forming the two-electrode assemblies on the surface of the substrate;
optionally, applying a coating layer onto at least a portion of the working electrode region of one or more of the two-electrode assemblies.
